(19) United States
(12) Patent Application Publication
(10) Pub. No.: US 2005/0172252 A1
(43) Pub. Date: Aug. 4, 2005

(54) Elastic assembly floor plan design tool

(75) Inventors: Chih-Liang Cheng, Fremont, CA (US); Chung-Do Yang, Saratoga, CA (US); Yan Lin, Fremont, CA (US); Kuo-Feng Liao, Saratoga, CA (US)

Correspondence Address: BANNER & WITCOFF, LTD., 1001 G STREET, N.W., WASHINGTON, DC, 20001-4597, US

(73) Assignee: Mentor Graphics Corp., Wilsonville, OR (US)

(21) Appl. No.: 10/979,868

(22) Filed: Nov. 1, 2004

Related U.S. Application Data
(60) Provisional application No. 60/517,358, filed on Nov. 2, 2003.
(60) Provisional application No. 60/612,877, filed on Sep. 24, 2004.
(60) Provisional application No. 60/612,878, filed on Sep. 24, 2004.

(51) Int. Cl. G06F 17/50

(52) U.S. Cl. 716/10; 716/8

(57) ABSTRACT

A tool that a user may employ to assemble the components of a circuit in a floor plan design. The tool provides a user interface that displays the placement of blocks in a floor plan design, and the routing of wires among the blocks. When the designer moves the placement of a target block, the user interface automatically moves any adjacent blocks that would impede the movement of the target block and any block that would impede a block moved in response to the movement of the target block. The user interface may also respond to movement of a target block by showing how various features of the circuit will change as a result of the move. Thus, the user interface may show that moving one block closer to another block will create undesired wiring congestion in the circuit. The user interface also may show when moving a block will result in wiring connections that are too long to maintain a desired voltage level. The tool may also automatically move the placement of related blocks as a group, so that various attributes, such as a minimum distance between adjacent blocks, are maintained.

### RELATED APPLICATIONS

This application is a continuation-in-part application of U.S. Provisional Patent Application No. 60/517,358, entitled “Elastic Assembly Tool, filed on Nov. 2, 2003, and naming Chih-Liang Cheng et al. as inventors, which application is incorporated entirely herein by reference. This application also claims priority to U.S. Provisional Patent Application No. 60/612,877, entitled “Chip Level Power/Ground Network Optimization Methodology,” filed on Sep. 24, 2004, and naming Ta-Cheng Lin et al. as inventors, which application is incorporated entirely herein by reference. Still further, this application claims priority to U.S. Provisional Patent Application No. 60/612,878, entitled “3D Viewing/Editing System,” filed on Sep. 24, 2004, and naming Yan Lin et al. as inventors, which application is incorporated entirely herein by reference.

### FIELD OF THE INVENTION

The present invention relates to the design of microdevices. Various aspects of the present invention are particularly applicable to the layout and design of hybrid digital and analog microcircuit devices.

### BACKGROUND OF THE INVENTION

Microdevices, such as microcircuits formed on a substrate, continue to become more and more complex. A conventional integrated circuit may contain several million transistors, making these devices very difficult to design and fabricate. Moreover, the layout of elements in a microcircuit design typically is not a linear process. Instead, the complexity of laying out the elements of a microcircuit more closely correlates to the formula n log n, where n is the number of elements in the design.

In order to address this complexity, microcircuit designers often will combine several smaller designs in a hierarchical arrangement to form a larger microcircuit design. Typically, each smaller design or “block” describes a group of circuit elements that have been configured to form one or more functional components. In some situations, this block for a group of circuit elements may be new. Frequently, however, a block will be copied from a library of existing designs. For example, rather than creating a new design for a memory device, a circuit designer may simply obtain a previously-created design of a memory device from a library of circuit components, or even a previously-created design for an array of cooperating memory devices. By using these groups or “blocks” of circuit elements that are arranged into one or more functional components, a designer can more easily create a larger microcircuit design to perform a desired task or to have desired features.

Even if a designer employs blocks of configured circuit elements to create a microcircuit, however, the designer must still physically arrange those blocks relative to each other for placement on a substrate. More particularly, the designer must create a “floor plan” for the microcircuit design. The floor plan will include the perimeter for the microcircuit design, which will define the size and shape of the microcircuit. It will also include the position of the various contact “pads” required by the microcircuit. These pads, arranged along the periphery the design perimeter, provide connection points for the power, ground, and input/output pins that will connect the microcircuit to a power supply, an electrical ground, and other devices. The blocks of circuit elements are then arranged within the “core” area inside of the contact pads. With some blocks, the size and shape of a block will be predefined. For other blocks, the block design may simply require a minimum area for the block. The particular height and length of the block then may be specified by the designer.

The floor plan may also include one or more of the conductive lines or “wires” that will be included in the microcircuit design. For example, a floor plan may include those wire structures that will take up a large amount of space in the circuit design. As will be appreciated by those of ordinary skill in the art, the power supply and ground wires that handle large currents typically are wider than signal wires that carry lower current clock signals, data signals and command signals. These power and ground wires thus may be included in a floor plan design. A guard band may similarly be included in a floor plan. A guard band is a barrier of conductive material used to shield circuit elements from electromagnetic interference. Depending upon the degree of shielding desired, the guard band thus may be a relatively large wire structure. Still further, groups of related signal wires (that is, wires for carrying clocking signals, data signals or command signals) may collectively form a bus. If it is important for the signals carried by these wires to be synchronized, then these signal wires may be arranged next to each other in parallel. This type of relatively large wire structure also may be included in a floor plan. Still further, critical signal wires (i.e., wires that carry a critical clock, data or command signal) may be included in a floor plan design.

The blocks must be positioned within the core area so that the electrical wiring connections to and from the blocks can be routed to comply with various design constraints. For example, signal wires carrying data or control signals between component blocks must be routed so that they are not congested and not too long. If the wires are too congested, then some of the wires may be shorted together during the manufacturing process. If the wires are too long, the currents that will be carried on the wires may drop below the threshold value needed to power or signal the connected component. Still further, if various data or control signal wires are arranged into a bus, then the wires must physically be kept together. If the wires are designed to lie along different routes, then propagation timing differences in the wires may cause the signals to be erroneously received out of synchronism.

In addition, the designer must be able to easily connect the power and ground inputs of every component to a power or ground wire such that each component receives the same amount of power in a consistent manner. Accordingly, primary power and ground lines (sometimes referred to as a power/ground “network” wires) typically must be routed throughout the entire area floor plan design. If the designer is uncertain as to the placement of the power and ground connections for a block, then the power/ground network wires may even need to be arranged to encircle the block. This power/ground network structure is sometimes referred to as a power/ground network “ring.”

The difficulty of arranging components for a microdevice becomes even greater if the device is a hybrid that includes both analog and digital circuits. With this type of design, the analog components of the device require a set of power, ground, data signal and control signal wires that are entirely separate from the power, ground, data signal and control signal wires for the digital components of the device. Further, the analog components of the device (or, alternately, the digital components of the device) typically will be encircled by a guard band that electrically shields the analog components from the digital components and vice versa.

In addition to the layout of the component blocks, the packaging for a microcircuit will also affect the routing of data signal, control signal, power and ground wires between the blocks. A microcircuit's package will have a fixed number of pins for external connections to the microcircuit, so the clock signal wires, data signal wires, control signal wires, power wires and ground wires for the blocks must be routed to the contact pads for these pins without congestion and without lengthening the wires beyond a maximum distance.

There are two types of routing for electrical connection wires: global routing and detailed (or “local”) routing. Global routing defines the overall directions in which the wires are laid out to avoid large structures. Detailed routing then specifies the local detours for the wires that are taken along those general directions to avoid other wires or smaller structures. Because of the complexity of the detailed routing process, this process is typically very time-consuming, so it usually is preferable to avoid congestion as much as possible during global routing, to simplify the detailed routing process.

Conventionally, the process of creating a floor plan design includes several steps. First, a designer will lay out a proposed floor plan for the component blocks. Next, the designer will assign pin placements for the microcircuit package by, for example, defining the locations of the contact pads for each pin. The designer will then globally route each group of large wiring structures among the blocks, such as power and ground wires, guard bands and signal wires grouped into a bus. If the final result does not produce a desired outcome (for example, if some of the wires are too congested), then this entire process has to be repeated until an acceptable floor plan is created using this “hit-or-miss” technique.

### BRIEF SUMMARY OF THE INVENTION

Various embodiments of the invention provide a tool that a designer may employ to more efficiently position or assemble the components of a circuit. More particularly, various examples of the invention provide a tool with a user interface that displays the global placement of blocks in a floor plan design, and the global routing of wires among the blocks. When the designer moves the placement of a block, the user interface responds by showing how various features of the circuit will change as a result of the move. For example, the user interface may show that moving one block closer to another block will create undesired wiring congestion in the circuit. The user interface also may show when moving a block will result in wiring connections that are too long to maintain a desired voltage level. With various embodiments of the invention, the tool may also automatically move the placement of related blocks as a group, so that various attributes, such as a minimum distance between adjacent blocks, are maintained.

### BRIEF DESCRIPTION OF THE DRAWINGS

FIG. 1 illustrates an example of a programmable computer that can be used to implement various embodiments of the invention.

FIG. 2 schematically illustrates an elastic assembly floor plan design tool according to various embodiments of the invention.

FIGS. 3A, 3B, 4A and 4B show various operations of a user interface that may be provided by an elastic assembly floor plan design tool according to various embodiments of the invention.

FIG. 5A illustrates an example of a floor plan design.

FIG. 5B illustrates a horizontal directional visibility graph corresponding to the floor plan design in FIG. 5A that may be employed according to various embodiments of the invention.

FIGS. 6A-6C illustrate a process for determining the routing of a wire network, such as a power/ground wire network according to various embodiments of the invention.

FIG. 7 illustrates a floor plan design having wire segments inserted into channel boxes between blocks.

FIG. 8 illustrates the routing of wire segments in a floor plan design having a rectilinear block.

FIG. 9 illustrates the routing of wire segments in a floor plan design having overlapping channel boxes.

### DETAILED DESCRIPTION OF THE INVENTION

Overview

Various embodiments of the invention provide a floor planning tool that allows a designer to easily position components of a microcircuit in a floor plan design, while maintaining desired attributes for the design. More particularly, different embodiments of the invention provide a designer with a user interface that can display the floor plan of a design for a microcircuit. As used herein, the term “block” refers to the representation in a floor plan design of any group of circuit elements in a microcircuit design that may be repositioned, added, deleted or otherwise manipulated as a group. By using a pointing device, such as a keyboard, mouse, stylus, touchpad, joystick or the like, a circuit designer can select and move the placement of one or more of the blocks making up the floor plan design. As the designer moves a selected “target” block, the user interface graphically displays the various changes in the circuit characteristics and design that will result from the movement of the target block.

For example, the user interface may indicate when the movement of the target block will cause the electrical connections near the block to become more or less congested. With some embodiments of the invention, the floor planning tool may even reroute electrical connections near the block based upon the block's movement. The tool's user interface may then display the new routing to the designer. If the designer is satisfied with the revised floor plan design and routing changes, the designer can choose to make the changes permanent to the floor plan design. If, however, the designer is dissatisfied with the new floor plan or its associated connection routing, the designer may then decline the changes displayed in the user interface, thereby maintaining the original floor plan design. In this manner, a design may experiment with different floor plan designs without modifying an original floor plan design.

With still other embodiments of the invention, the floor planning tool may also change one or more features of the circuit design in response to movement of a block in order to maintain one or more desired attributes. For example, a designer may specify that all blocks within a floor plan design maintain a minimum separation distance from each other. If the designer moves a target block too close to an adjacent block (i.e., a block adjacent to the target block), then these embodiments of the invention may move the adjacent block to maintain the minimum specified distance between the blocks of the circuit design. Some embodiments may also move one or more blocks that are adjacent to the first adjacent block in order to maintain the minimum specified distance between the blocks. Thus, when a designer moves a target block to assemble a floor plan design, the user interface may “elastically” move one or more adjacent blocks in response.

With various embodiments of the invention, a designer may select which features of the circuit design are displayed in the user interface. For example, a designer may wish only to view the impact that moving a block will have on the routing of the power/ground network wires in the circuit. In other circumstances, however, the designer may wish to view the changes to one or more signal wires that would result from moving a block, or to both the power/ground network and signal wires.

Operating Environment

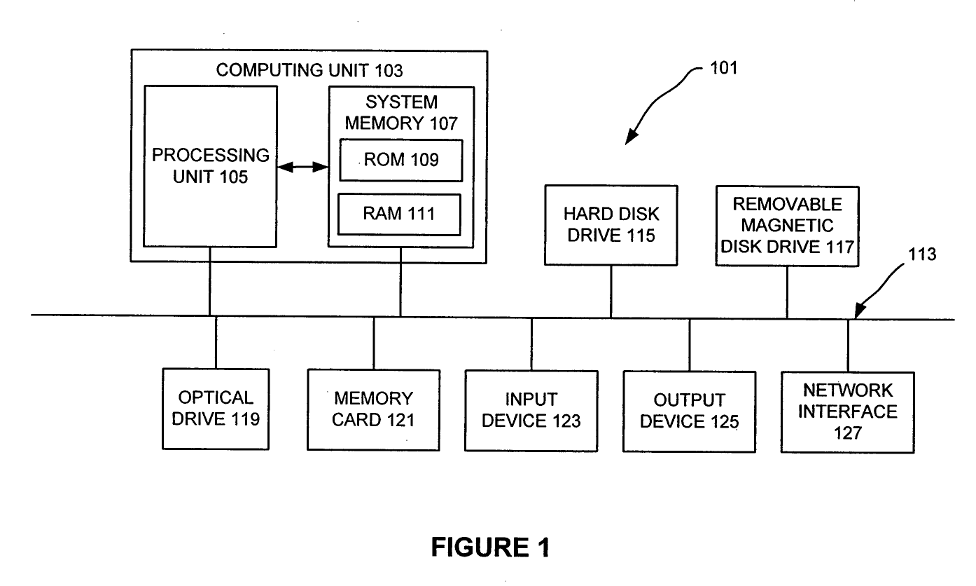

Various embodiments of the invention may be implemented through the execution of software instructions by a computing device, such as a programmable computer. An illustrative example of such a computing device 101 is illustrated in FIG. 1. As seen in this figure, the computing device 101 has a computing unit 103. The computing unit 103 typically includes a processing unit 105 and a system memory 107. The processing unit 105 may be any type of processing device for executing software instructions, but will conventionally be a microprocessor device. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional memory storage devices, such as a hard disk drive 115, a removable magnetic disk drive 117, an optical disk drive 119, or a flash memory card 121. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers.

With some implementations, the computing unit 103 may be directly or indirectly connected to one or more network interfaces 127 for communicating with a network. The network interface 127 translates data and control signals from the computing unit 103 into network messages according to one or more communication protocols, such as the transmission control protocol (TCP) and the Internet protocol (IP). These protocols are well known in the art, and thus will not be discussed here in more detail. An interface 127 may employ any suitable connection agent (or combination of agents) for connecting to a network, including, for example, a wireless transceiver, a modem, or an Ethernet connection.

It should be appreciated that one or more of these peripheral devices may be housed with the computing unit 103 and bus 113. Alternately or additionally, one or more of these peripheral devices may be housed separately from the computing unit 103 and bus 113, and then connected (either directly or indirectly) to the bus 113. Also, it should be appreciated that both computers and computing appliances may include any of the components illustrated in FIG. 1, may include only a subset of the components illustrated in FIG. 1, or may include an alternate combination of components, including some components that are not shown in FIG. 1.

The Elastic Assembly Floor Plan Design Tool

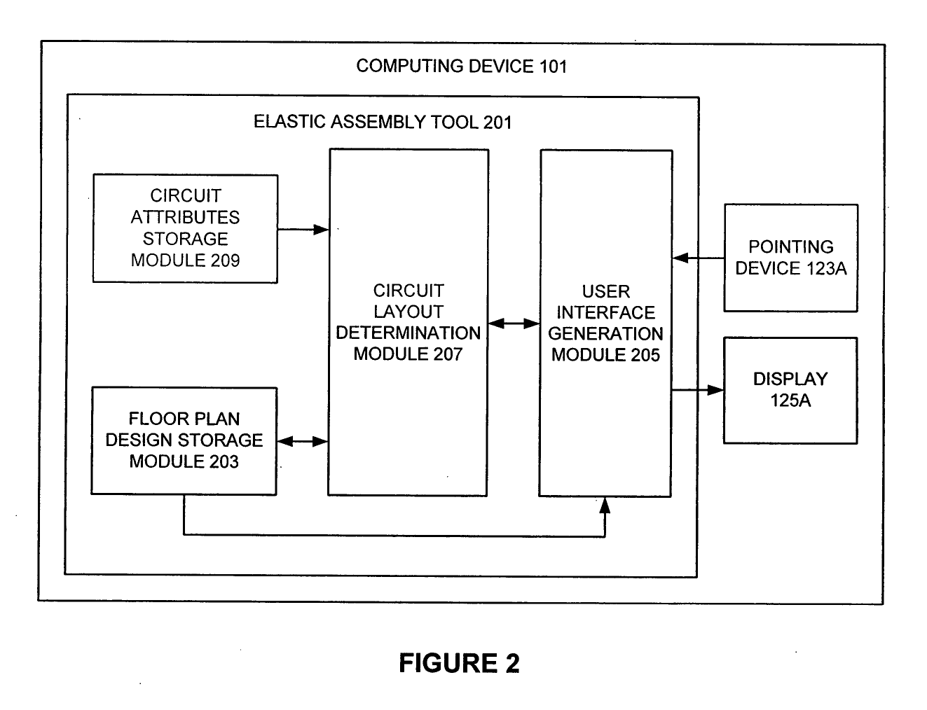

FIG. 2 schematically illustrates an elastic assembly floor plan design tool 201 that may be implemented according to various embodiments of the invention. As seen in this figure, the tool 201 includes a floor plan design storage module 203, a user interface generation module 205, and a circuit layout determination module 207. The elastic assembly floor plan design tool 201 may also optionally include a circuit attributes storage module 209. As previously noted, each of these modules may be implemented by modules of software instructions that can be executed by a programmable computer stored on a storage medium, through the execution of such software instructions by a programmable computer, by the storage of data on a storage medium, or a combination of thereof.

The floor plan design storage module 203 stores one or more floor plan designs for a microcircuit. These floor plan designs may include one or more existing circuit design layouts that already contain blocks representing one or more components of the microcircuit. Alternately, these floor plan designs may include a blank template to which a designer can add blocks during a design process. In addition to the layout of the blocks, a floor plan design may also include the layout of various other features of the microcircuit, such as the routing of various connection wires associated with the blocks. For example, a floor plan design may include features of power and ground wires, such as power/ground network wires, that will provide electrical power to the components of the circuit.

A floor plan design may alternately or additionally include features for one or more signal wires that will transmit clocking, control and/or data signals to and from the microcircuit components. For example, as previously noted, a “bus” of related signal wires will take up more space than an individual signal wire, so a designer may wish to view the routing of bus signal wires in a floor plan design. Alternately or additionally, a designer may wish to include one or more individual signal wires carrying critical signals in a floor plan design, to ensure that these signal wires are optimally routed. Of course, any desired feature of a circuit design may be included in a floor plan design according to various embodiments of the invention.

The floor plan design data may be created or stored in any conventional data format that will represent the desired floor plan design structures. For example, various embodiments of the invention can maintain and manipulate the floor plan design in convenient design data formats, such as the Library Exchange Format/Design Exchange Format (LEF/DEF), the “Open Access” database format, or the “Milkyway” data format, each of which are well known in the art, and thus will not be discussed here in further detail. Still other embodiments of the invention may alternately or additionally employ more complex formats (i.e., formats that provide additional information unnecessary for maintaining and manipulating a floor plan design), such as the GDS II data format or the OASIS data format. With these embodiments, the tool may maintain and manipulate the floor plan design directly in the more complex data format, or convert the more complex data format into a simpler, more convenient design data format such as those listed above. Still other embodiments of the invention may additionally convert the finished floor plan design from a simpler, more convenient design data format into a more complex data format for manufacturing or final verification of the microcircuit design.

When the tool is initiated, the floor plan design storage module 203 provides an initial floor plan design to the user interface generation module 205. For example, the user interface generation module 205 may generate a user interface that includes a menu for selecting among one or more floor plan designs stored in the floor plan design storage module 203. The designer can then select a desired floor plan design using the menu. The selected floor plan design will then be displayed by the user interface generation module 205 in a user interface. Of course, any other desired techniques may be used to retrieve and display a desired floor plan design from the floor plan design storage module. In the illustrated embodiment of the invention, the floor plan design storage module 203 provides the initial floor plan design to the user interface generation module 205. With alternate embodiments of the invention, however, the floor plan design storage module 203 may provide an initial floor plan design to the user interface generation module 205 through the circuit layout determination module 207.

The user interface generation module 205 displays a user interface showing the initial floor plan design on a display 125A. With various embodiments of the invention, the user interface generation module 205 may display only those features of the initial floor plan design selected by a user. For example, with these embodiments, a user may instruct the interface generation module 205 to display only the blocks of the initial floor plan design, to display the blocks along with the power network wiring and the ground network wiring for the design, to display one or more of the signal bus wires for the design, to display the guard bands for the design, or to display any combination of these or other desired items. In some embodiments of the invention, the user interface generation module 205 may selectively filter features of the initial floor plan design from being displayed in the user interface. With still other embodiments of the invention, however, the user interface generation module 205 may only receive only the desired portions of the initial floor plan design from the floor plan design storage module 203 for display.

In order to properly render the user interface with the initial floor plan design, the user interface generation module 205 may include various application programming interfaces or other components necessary to create graphic images corresponding to the initial floor plan design. Also, while the user interface generation module 205 is illustrated as being a part of the elastic assembly tool 201, with alternate embodiments of the invention one or more functions of the user interface generation module 205 may be performed by external software applications, such as the operating system for the computing device 101. The display 125A may be any desired type of display including, for example, a cathode ray tube display, a plasma screen display, or a liquid crystal display (LCD).

When a designer wishes to modify the initial floor plan design (or create a new floor plan design from a blank template), the user controls the information graphically displayed in the user interface by manipulating one or more of the input devices 123, such as the pointing device 123A. The pointing device 123A may be any desired pointing device, such as a keyboard, a mouse, a touchpad, a joystick, a stylus operating with a digitizer, or a combination of two or more pointing devices. As will be explained in more detail below, a designer may control the user interface to change the position of a block in the initial floor plan design. For example, a designer may use the pointing device 123A to select a “target” block, and then subsequently move the target block within the display of the initial floor plan design. Alternately or additionally, a designer may use the pointing device 123A to create and position a new block in the display of the initial floor plan design, or to remove an existing block from the initial floor plan design.

In response to the user input from the pointing device 123A, the user interface generation module 205 will change the displayed position of the target block in the user interface. In addition, the user interface generation module 205 will provide the movement of the target block to the circuit layout determination module 207. As will be explained in detail below, the circuit layout determination module 207 determines a new layout for the relevant features of the floor plan design based upon the new position of the target block. This new floor plan design may then be displayed to the user. For example, the circuit layout determination module 207 may determine new routing for power and ground network wires that corresponds with the changed position of the target block.

The circuit layout generation module 207 can further have the user interface generation module 205 display one or more of the changes to the initial design floor plan features in the user interface. If the user is satisfied with the revised floor plan design, then the user can choose to make the changes permanent by saving the modified floor plan design in the floor plan design storage module 203. With some embodiments of the invention, however, if the user is dissatisfied with the new floor plan, the user may then decline the changes displayed in the user interface and thereby maintain the initial floor plan design. In this manner, a user may view and consider different floor plan design changes without modifying the initial floor plan design.

Various embodiments of the invention may include the circuit attributes storage module 209. As will be explained in more detail below, the circuit attributes storage module 209 stores desired attributes for various features of the floor plan design. Thus, the circuit attributes storage module 209 may specify a maximum or minimum distance between various blocks in a floor plan design. Similarly, the circuit attributes storage module 209 may specify a maximum or minimum distance between various wires within the design (e.g., a minimum distance between power wires and ground wires), a maximum or minimum distance between various wires and blocks within the design (e.g., a minimum distance between a block and a power wire), and a minimum width of a wire.

The circuit layout determination module 207 will then revise the floor plan design so that it complies with the requirements specified in the circuit attributes storage module 209. For example, if a designer attempts to move a target block closer than a minimum distance specified in the circuit attributes storage module 209, the circuit layout determination module 207 will not make this change to the floor plan design. Further, the circuit layout determination module 207 may have the user interface generation module 205 prevent the user interface from showing the prohibited movement. With various embodiments of the invention, the attributes included in the circuit attributes storage module 209 may be provided before the tool 201 is employed, specified by the designer during the floor plan design process, or a combination of both.

The User Interface

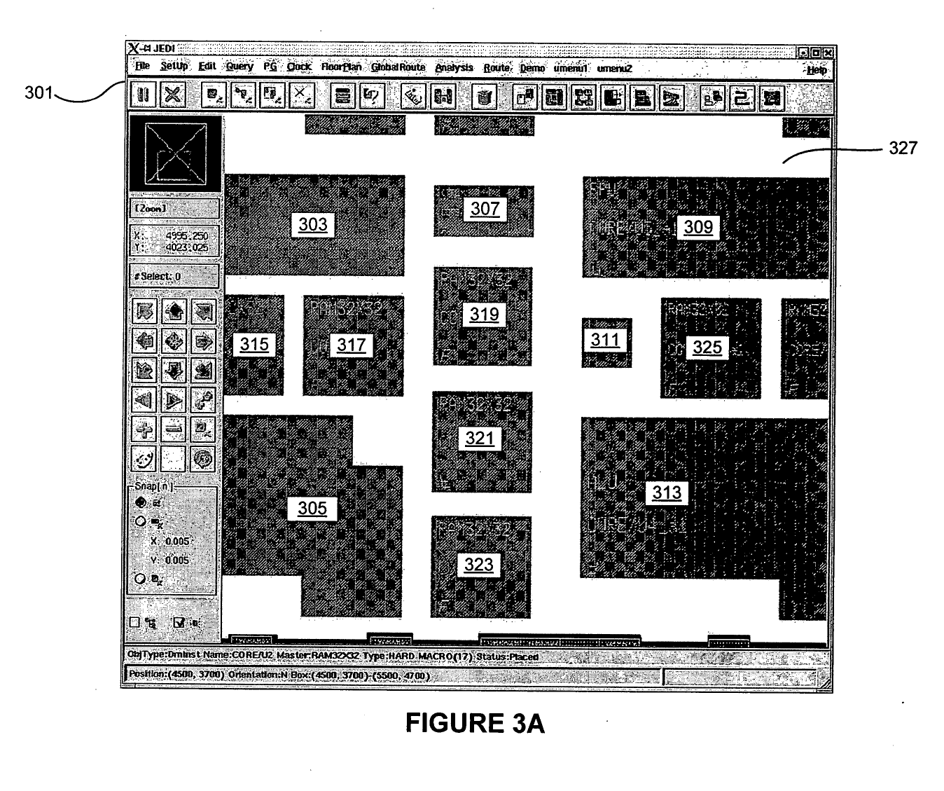

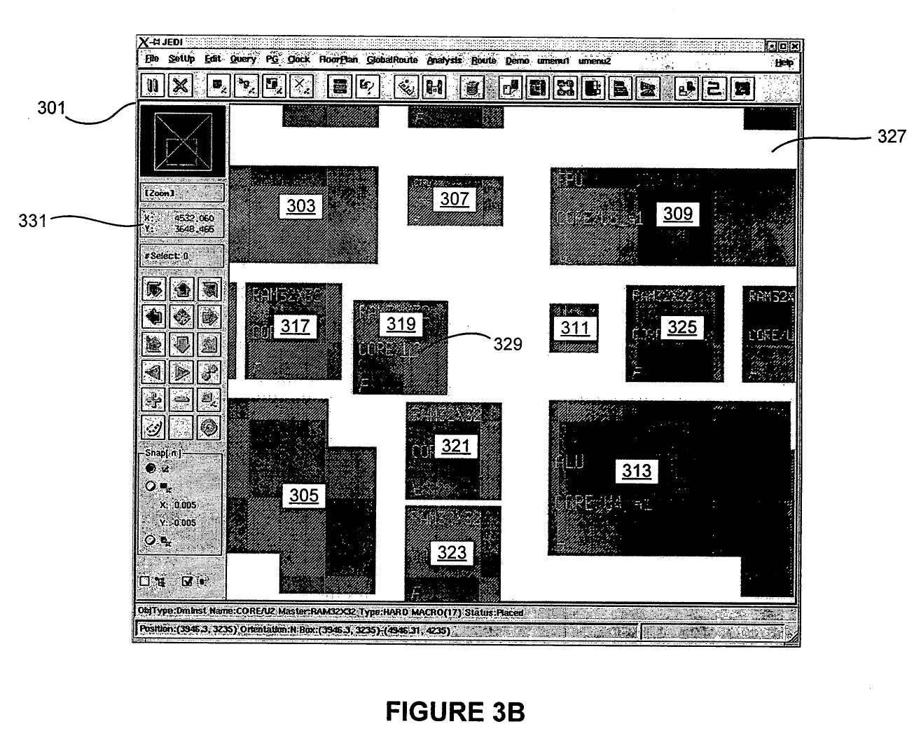

FIG. 3A illustrates one example of a user interface 301 that may be provided to a designer according to various embodiments of the invention. As seen in this figure, the interface 301 displays a floor plan design including various blocks 303-325 representing different components of a microcircuit. For example, block 309 may represent the circuit structures making up a floating point processing unit, while block 313 may represent the circuit structures making up an arithmetic logic unit. Blocks 315-325 may each then represent circuit structures making up a memory device. Each of the blocks 303-325 is displayed on a substrate representation 327, which corresponds to the substrate in which the microcircuit structures represented by the blocks 303-325 will be formed.

In the illustrated embodiment, the blocks 303 and 307-311 and 315-325 are rectangular, while blocks 305 and 313 have irregular shapes that may be formed by overlapping rectangular shapes. Different embodiments of the invention may alternately or additionally provide for blocks of any desired shape. It should be appreciated, however, that the use of rectilinear blocks having only right angles may allow for easier determination of the features of the microcircuit when a block is moved, as will be explained in more detail below.

As previously noted, a designer may employ the user interface 301 to change the floor plan design by moving one or more of the blocks 303-325. More particularly, a designer can manipulate the pointing device 123A to select and move a block shown in the user interface 301. For example, FIG. 3B illustrates an alternate placement of the blocks 303-325. In this example, the designer has selected block 319 as the “target” block (as indicated by, e.g., the cross-shaped target cursor 329 shown in the block 319). As will be appreciated by those of ordinary skill in the art, various embodiments of the invention may employ a coordinate system, such as an X-Y Cartesian coordinate system, to identify the placement, movement and orientation of the blocks relative to the floor plan design.

With some embodiments of the invention, the circuit layout determination module 207 may determine the coordinate values for the current position of the target cursor 329, which then may be displayed by the user interface 301 in a position coordinates field 331. This coordinate information may then be included as part of the floor plan design. With still other embodiments of the invention, the user interface generation module 205 may itself determine and display the coordinate values for the current position of the target cursor 329 as a feature of the user interface 301.

Between the view of the user interface 301 shown in FIG. 3A and the view of the user interface 301 shown in FIG. 3B, the user has moved the block 319 down and to the left. (It should be noted that the use of relative directions throughout is made only to more conveniently explain various features and operations of the invention, and should not be considered limiting.) In addition to moving the target block in response to a user's commands, some embodiments of the invention may also move blocks proximal to the target block or another moved block. For example, in FIG. 3B, the designer has moved the target block 319 into the area originally occupied by the adjacent blocks 317 and 321 in FIG. 3A. In response, the circuit layout determination module 207 has repositioned the placement of the adjacent blocks 317 and 321. The new positions for these blocks 317 and 321 are then displayed in the user interface 301, as shown in FIG. 3B.

More particularly, as shown in FIG. 3B, the circuit layout determination module 307 has moved the block 317 (located to the left of the block 319) in the left direction. The circuit layout determination module 207 has similarly moved the block 321 (located below the block 319) in the downward direction. Still further, the circuit layout determination module 207 has moved the block 323 adjacent to the moved block 321 (located below the block 321) in a downward direction as well. Thus, one or more of the blocks in a floor plan design may be “elastically” moved to accommodate the movement of a target block. It should be noted that, while only two adjacent blocks are moved in the illustrated example (i.e., blocks 317 and 315 and blocks 321 and 323), any number of blocks may be recursively moved in response to the user's movement of a target block.

As also noted above, with various embodiments of the invention the elastic assembly tool 201 may be configured to maintain or enforce one or more circuit attributes defined in the circuit attributes storage module 209. For example, with the illustrated embodiment, the circuit attributes storage module 209 may specify a minimum distance to be maintained between each of the blocks 303-325. The circuit layout determination module 207 will then identify when the user has moved the target block 319 to within this minimum distance from the adjacent block 317. If the user continues to move the target block 319 towards the adjacent block 317, the circuit layout determination module 207 will move the adjacent block 317 away from the target block 319 to maintain the specified minimum distance. Further, the movement of the adjacent block 317 may be displayed for the user in the user interface 301, as illustrated in FIG. 3B.

Similarly, the circuit layout determination module 207 will identify when the user moves the target block 319 to within a minimum specified distance from the adjacent block 321. If the user continues to move the target block 319 towards the adjacent block 321, then the circuit layout determination module 207 moves the adjacent block 321 away from the target block 319 to maintain this specified minimum distance. Further, as the adjacent block 321 reaches its minimum specified distance from its adjacent block 323, the circuit layout determination module 207 moves the block 323 away from the block 321 to preserve the minimum distance separation between the two blocks. The movement of the adjacent blocks 321 and 323 also may be displayed for the user in the user interface 327, as also illustrated in FIG. 3B.

Different embodiments of the invention may allow the circuit attributes storage module 209 to specify any desired attributes for a floor plan design. For example, some embodiments of the invention may allow the circuit attributes storage module 209 to designate different minimum or maximum distances between different blocks, and even to designate different minimum or maximum distances to be maintained on each side of a block. The circuit attributes storage module 209 may also specify a minimum or maximum distance to be maintained between two or more blocks. This type of attribute may be employed, for example, when blocks are related and should be positioned relatively close to each other.

The circuit attributes storage module 209 may alternately or additionally specify attributes relating to other features of the floor plan design, such as wire or guard band placement. For example, the circuit attributes storage module 209 may specify minimum or maximum wire widths or lengths, a maximum level of congestion permitted for wire routing, or a minimum or maximum distance between different types of wiring lines. Further, with some embodiments of the invention, the circuit attributes storage module 209 may even specify that some wiring lines, such as a main power or ground network wires, are maintained a first minimum distance from a first type of block, and a second minimum distance from another type of block. This allows, for example, a power or ground network wire to be kept at a greater minimum distance from a block that is particularly sensitive to noise from that wire.

With some embodiments of the invention, the attributes stored in the circuit attributes storage module 209 will be provided by the user. For example, the user may create an electronic file with the desired circuit attributes, and then download the file in whole or in part to the circuit attributes storage module 209. Alternately or additionally, a user may modify or create new circuit attributes during the design process. More particularly, the user interface 301 may allow the user to modify existing attributes stored in the circuit attributes storage module 209, create and store new circuit attributes in the circuit attributes storage module 209, or both. With some embodiments of the invention, one or more circuit attributes may be defined by another party as desired. For example, with some embodiments of the invention, a foundry that will manufacture the microcircuit may specify one or more circuit attributes that will be stored by the circuit attributes storage module 209.

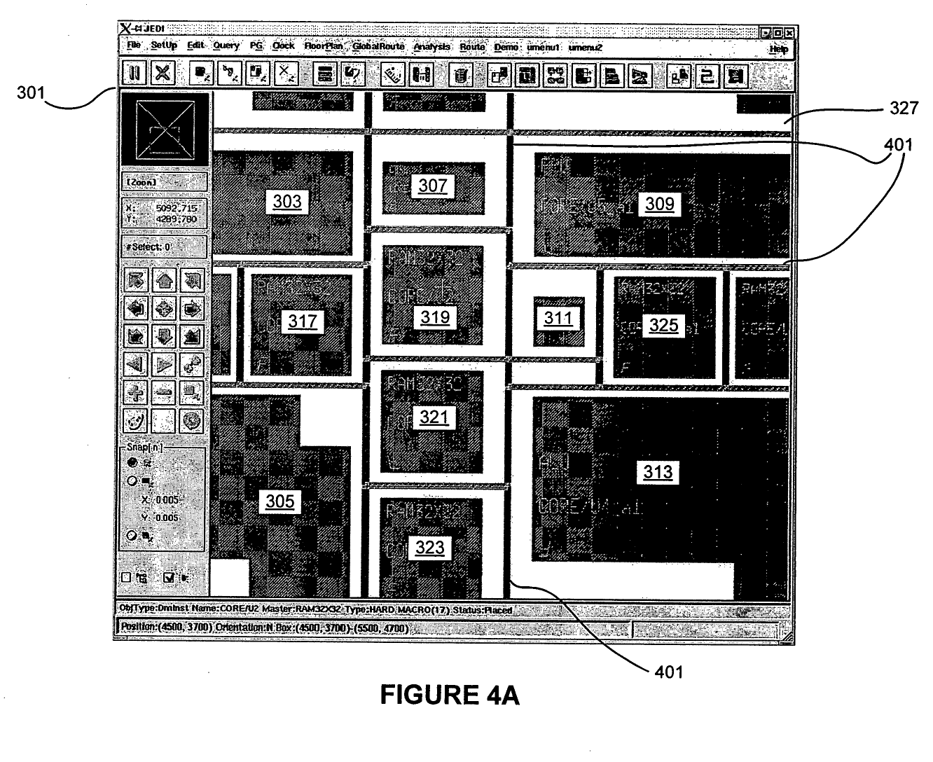

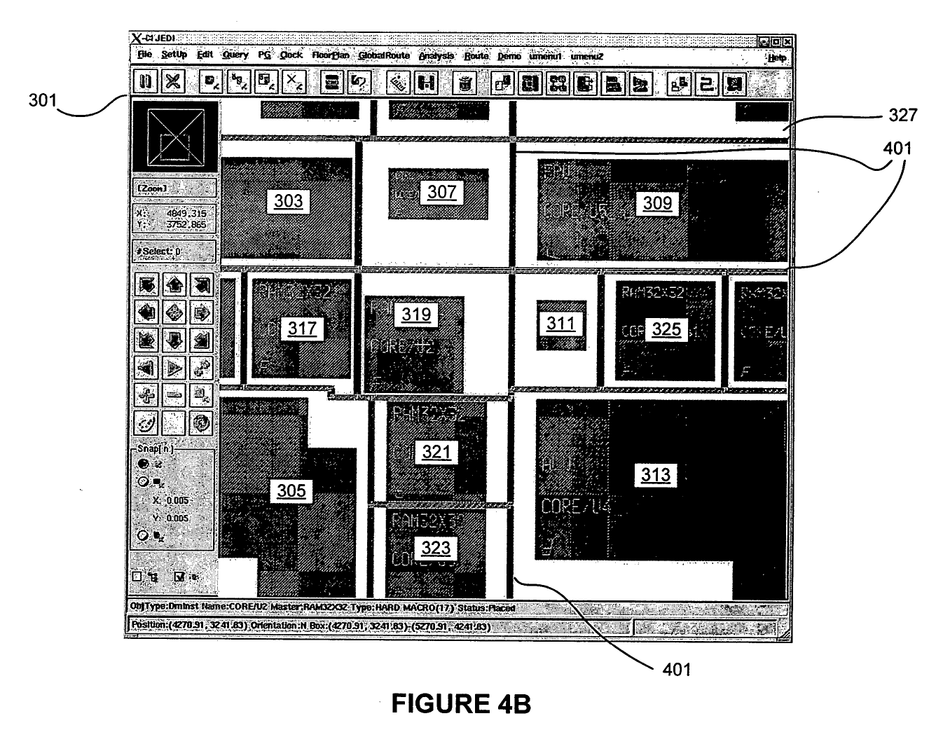

The user interface 301 may be configured to display only the positions of the blocks 303-325, as illustrated in FIGS. 3A and 3B. If, however, a user wishes to view one or more other features of the floor plan design, then the user may activate a command provided by the user interface to display the desired features. Such features may include power, ground, or signal wire routing, guard band placement, and a congestion map showing congestion for one or more types of wire connections. For example, as shown in FIG. 4A, the user interface generation module 205 may be instructed to have the user interface 301 display the routing of the power and ground network wires 401 for the floor plan design. That is, a designer may choose to have the user interface 301 display the portion of the floor plan design that includes the routing path of the power and ground network wires 401 for the current placement of the blocks 303-325.

As will be appreciated by those of ordinary skill in art, moving one or more blocks in a floor plan design may impact other features of the design, including design features that may be displayed by the user interface 301. For example, moving a block may require that one or more primary or secondary power and ground wires proximal to that block are rerouted as well. Similarly, moving a block may alternately or additionally require that one or more primary or secondary and signal wires near the block be rerouted. Accordingly, with various embodiments of the invention, the circuit layout determination module 207 may determine what impact the movement of a block will have on other features of floor plan design, and display these changes in the user interface 301.

For example, by displaying the power and ground network wires 401 as shown in FIGS. 4A and 4B, the designer can view how movement of the block 319 (and the corresponding movement of the blocks 317, 321 and 323) changes the routing of the power and ground network wires 401 in the floor plan design. More particularly, the designer can determine that moving the block 319 will change the routing of the power and ground network wires 401 between the blocks 319 and 321, between the blocks 311 and 313, between the blocks 317 and 305, between the blocks 303 and 307, between the blocks 317 and 319, and between the blocks 321 and 323.

Thus, when moving the target block 319, the user can immediately view the effect of this movement on other features of the floor plan design. With some embodiments of the invention, the user interface 301 may additionally display features of the floor plan design that will change in response to rerouting of wiring connections. The user interface 301 may thus be configured to display the amount of congestion associated with a particular wire routing. For example, if the user interface 301 displays the routing for the main power and ground network wires 401, the user interface 301 may additionally indicate the level of congestion associated with these wires 401. If a portion of the main power and ground connection wires 401 are not congested, then the user interface 301 may display this portion, e.g., in a first color, such as green. If a portion of the power and ground network wires 401 are mildly congested, then the user interface 301 may display this portion in a second color, such as yellow. If a portion of the power and ground network wires 401 is heavily congested, then the user interface 301 may display this portion in still another color, such a red. A similar congestion indication scheme may then be used to indicate congestion for signal wires. Of course, any desired indication scheme, such as hatching or shading, alternately may be used to indicate relative congestion of power, ground and signal wires.

It also should be appreciated that different embodiments of the invention may evaluate the congestion of various wiring connections using any desired criteria, such as the number of different wires per area, placement of the wires within a threshold distance of each other, etc. Further, various examples of the invention may identify more or less than the three different levels of congestion as described above.

While wire congestion has been discussed as one example, it should be noted that various embodiments of the invention may display any desired characteristics of floor plan design features in the user interface 301. For example, some embodiments of the invention may alternately or additionally show where wires in the floor plan design will suffer an undesired voltage (or “IR”) drop. With these embodiments of the invention, the user interface may, e.g., identify such drops with an “X” marking or other recognizable identifier.

With some embodiments of the invention, the circuit layout determination module 207 may update one or more features of a floor plan design upon a movement of the blocks 303-325, regardless of whether those features contemporaneously are displayed by the user interface 301. With still other embodiments of the invention, however, the circuit layout determination module 207 may determine the current status of features of the floor plan design only when those features are to be displayed by the user interface 301.

Also, with various embodiments of the invention, other features of a floor plan design are determined only after a user has fixed the placement of the blocks. With still other embodiments of the invention, however, these other features of the floor plan design may be determined and displayed to the user in real-time (i.e., as the user is moving a block). This type of immediate feedback allows a user to more quickly and naturally determine a suitable placement for the blocks in a floor plan design, and to readily ascertain when movement of a block may reduce the performance or yield of a circuit.

In order to provide faster feedback to a user, various embodiments of the invention may employ one or more techniques to reduce processing overhead. For example, some embodiments of the invention may provide faster global routing for, e.g., signal wires, by simplifying the number of material layers represented in the routing determination. Thus, while a conventional microcircuit may actually use six to eight different layers of material for routing signal wires, a fast global routing process according to various examples of the invention may only assume that two layers exist for routing signal wires (e.g., one layer for carrying wires in a first direction, and another for carrying wires in a second direction orthogonal to the first direction). This provides a user with an indication of routing and congestion problems associated with block movements, without requiring a detailed determination of routing in all of the available connection layers.

Still further, the circuit layout determination module 207 may only determine global routing for wires, without determining local routing. In addition to reducing processing overhead, omitting local routing of wires may provide a user with a more accurate indication of the congestion associated with the wires. Still further, the process for determining the characteristics of a circuit may only be performed until new or further movement of a block is detected (e.g., until new data from the pointing device indicating movement of a block is detected). If the circuit layout determination module 207 detects that a block is being moved, then the circuit layout determination module 207 can postpone determining the design changes until the movement of each block is paused or completed.

With some embodiments of the invention, changes to a floor plan design are only temporarily displayed until a user decides to change the floor plan design, as noted above. This arrangement allows a user to return to the original layout of a floor plan design if changes to the design are not acceptable. Still other embodiments of the invention, however, may store one or more intermediate arrangements of the floor plan design, to allow a user to reference various proposed changes to the design.

Visibility Graph

Many features of a floor plan design, such as the routing of power, ground, signal and guard band wires, will depend upon relationships between the various blocks in the design. Accordingly, various embodiments of the invention may employ visibility graphs to describe geometric relationships between the blocks of a floor plan design. A visibility graph represents the relative locations of objects within a domain of interest, such as blocks within a floor plan design. More particularly, visibility graphs provide an efficient tool to quickly identify which block in a floor plan design is directly and indirectly “visible” to another block, as will be explained in detail below. Accordingly, a visibility graph can be used to determine, when a designer moves one block in a floor plan design, which of the other blocks will need to be moved as well (and which blocks cannot be moved due to various restrictions). A visibility graph also can be used to help quickly determine global routing for the main power, ground, signal and guard band wires.

With various embodiments of the invention, a complete visibility graph is made up of two directional visibility graphs, with each directional visibility graph being oriented according to a direction orthogonal to the direction of the other directional visibility graph. Thus, a complete visibility graph may be comprised of a “vertical” visibility graph (describing the “visibility” of the blocks to each other only in a vertical direction) and a “horizontal” visibility graph (describing the “visibility” of the blocks to each other only in a vertical direction).

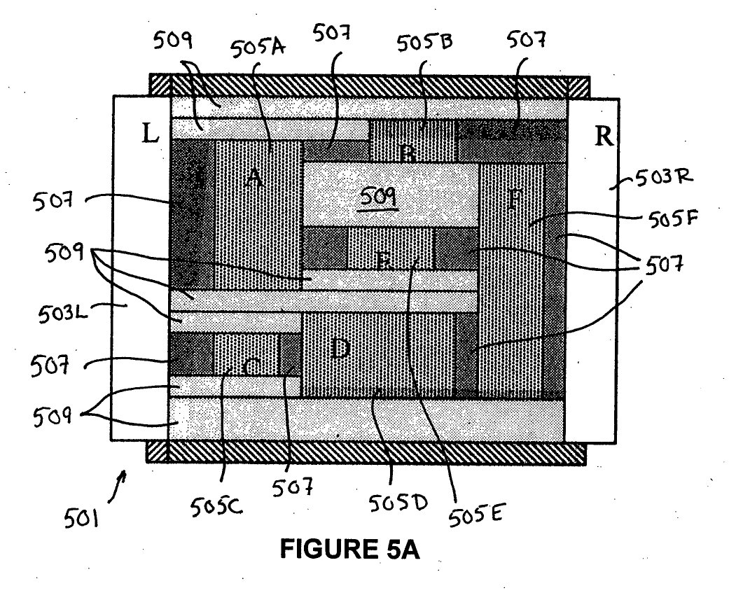

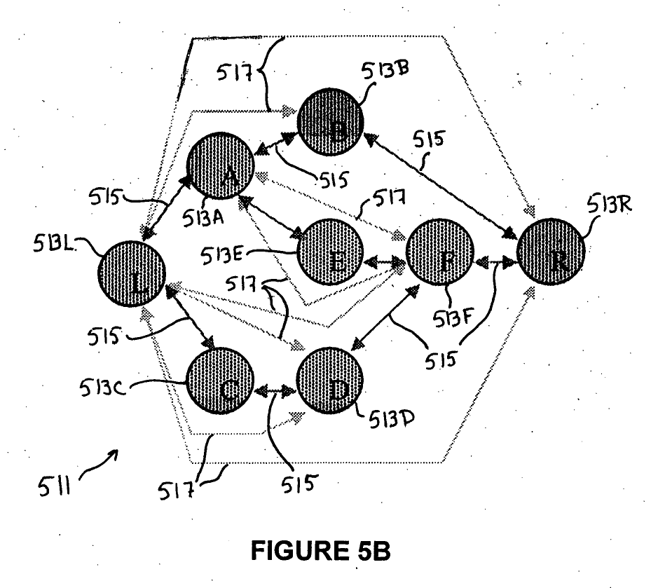

FIG. 5A illustrates an example of a floor plan design 501. The floor plan design 501 has a “left” side or boundary 503L, a “right” side or boundary 503R, and a number of different blocks 505A-505F. There also are a number of empty spaces (in this example, rectangular spaces) between the sides 503 and the blocks 505. As shown in this figure, however, these spaces can be categorized into two groups. The spaces 507 contact only two blocks 505, while the spaces 509 contact three or more blocks 505.

FIG. 5B illustrates a horizontal visibility graph 511 corresponding to the floor plan design 501 shown in FIG. 5A. As seen in this figure, each horizontal side 503 of the floor plan design 501 is represented by a node 513 in the graph 511. In addition, each block 505 in the floor plan design 501 also is represented by a node 513 in the graph 511. Thus, the node 513L corresponds to the left side 503L of the floor plan design 501, while the node 513R corresponds to the right side 503R of the floor plan design 501. Nodes 513A-513F then correspond to blocks 505A-505F, respectively.

An “edge” in the visibility graph corresponds to an empty rectangular space (in the graph's direction) between two blocks 505. An edge can be a primary edge or a secondary edge, however. An edge between two nodes X and Y is a secondary edge if and only if there exists another path from node X to node Y that contains at least one other node Z. That is, a secondary edge is an edge between two nodes where there exists a longer path (in terms of the total number of edges and nodes) between the same node pair. All other edges then are primary edges. Thus, the rectangular spaces 507 in the floor plan design 501 are represented by the primary edges 515, while the rectangular spaces 509 are represented by the secondary edges 517. Depending upon the arrangement of the blocks in a floor plan design, there may be two or more edges between the same pair of nodes. For instance, in the floor plan design 501, there are two empty rectangles of space between the blocks 505A and 505F, so there are two edges 517 between the node 513A and the node 513F. Such pairs of edges will not typically be merged.

A vertical directional visibility graph can then similarly be constructed for the floor plan design 501. The two directional visibility graphs will not be independent from each other, however. When one graph is modified due to the movement of a block, the configuration of the other visibility graph will need to be updated as well. Therefore, when a block in the floor plan design is moved, the two visibility graphs will be updated in an alternating fashion. With this alternating update sequence, corner-to-corner overlap of the visibility graphs can be avoided during incremental update and change. The determination of which directional visibility graph will be updated first may vary, however, depending upon the floor plan design. For example, a floor plan design may have more blocks (or more wire routing) in a horizontal direction, so it may be more efficient to update the vertical visibility graph for that floor plan design before updating the horizontal floor plan design.

As previously noted, various embodiments of the invention may be implemented with a programmable computing device executing software instructions. With these embodiments, the visibility graphs for a floor plan design may in turn be implemented using a data structure that is accessible to the programmable computing device. Because both the horizontal visibility graph and the vertical visibility graph for a floor plan design share a common set of nodes, the two directional visibility graphs can be merged into a single, “complete” visibility graph in such a data structure. With such a complete visibility graph, the edges may be grouped into vertical and horizontal edges. The complete visibility graph, however, will still distinguish between primary and secondary edges.

More particularly, a data structure implementing a complete visibility graph for a floor plan design may store four pointers to four nodes representing the four sides of the floor plan design. Other relevant information also may be stored in this anchor structure, such as a pointer to a duplicated or temporary visibility graph. A node in the data structure for the complete visibility graph will either represent a side of the floor plan design or a block within the floor plan design. Because a block may be rectangular or rectilinear, the node corresponding to a block will store a list of rectangles forming the block's boundary. Alternately, if the block has a polygonal shape, a node corresponding to that block may store a polygon as the block's boundary, but, as will be appreciated by those of ordinary skill in art, this node information requires additional processing steps to be useful.

As previously noted, a path between two blocks in the floor plan design is defined as an edge in the data structure describing the complete visibility graph. An edge connects exactly two nodes, and a primary edge in the data structure for a complete visibility graph represents the empty space between the two blocks corresponding to those nodes. As will be discussed in more detail below, this empty space serves as a channel area or channel “box” through which connection wires, such as power/ground network wires, can be routed. An edge in the data structure therefore will store the boundary of the rectangular area that it represents. Further, a primary edge will include some information identifying it as a primary edge, as opposed to a secondary edge. Edges corresponding to spaces on each side of a block may be sorted from bottom to top, and left to right.

With different embodiments of the invention, a variety of functions or “client” operations may conveniently employ the information contained within the complete visibility graph for a floor plan design. For example, as noted above and as will be discussed in greater detail below, some embodiments of the invention allow the tool to determine and display global routing for the power and ground network wires. Still other embodiments of the invention may enable client operations that determine and display global routing for the signal wires (such as critical or bus signal wires), pin assignments (for the blocks or the entire design), or any other desired feature of a microcircuit design. With various embodiments of the invention, these client operations may be implemented both within and external to the elastic assembly tool.

Accordingly, each node or edge in the data structure may contain a pointer to a linked list of client pointer holders. A client pointer holder consists of a pointer to the next client pointer holder, a client pointer and a signature of the pointer. When a client accesses its own client pointer, various embodiments of the invention may require the client to identify itself through a signature to use the completed visibility graph. This configuration allows each of the client operations to store and retrieve the values associated with the edges of the data structure for the complete visibility graph, thereby permitting the complete visibility graph to be shared among different client operations.

Wire Attributes

As discussed above, some embodiments of the invention may be used to determine and display various features of a floor plan design, including power, ground, signal and guard band wire routing. Accordingly, an example of the determination of power and ground network wires will now be described for illustration. The term “power and ground network,” as used herein, refers to the primary power and ground wires that include the combination of core rings (i.e., one or more main power and ground wires that ring the core area) and block rings (i.e., one or more main power and ground wires that ring at least a portion of a block) used to supply a power and ground voltage to various blocks in the floor plan design. This type of network typically does not include pin connections or individual connection wires between the rings and the blocks for simplicity, but various embodiments of the invention may include one or more such pin connections or individual connection wires where desired (e.g., where an individual connection wire is a critical connection). It should be appreciated, however, that various embodiments of the invention may similarly route any desired type of wires, including clock signal wires, data signal wires, and command signal wires.

As previously noted, the elastic assembly tool 201 may include a circuit attributes storage module 209 defining various attributes for the floor plan design. Thus, the circuit attributes storage module 209 may include attributes relating to the routing of the wires making up the power and ground networks. These attributes may, for example, dictate the width of the main power and ground wires, as will be explained in more detail below.

The circuit attributes the circuit attributes storage module 209 may include both global attributes and local attributes. Global attributes are universally imposed, while local attributes are imposed only for specific features of the design or within a specific region of the design. For example, global attributes for power and ground network wires will apply to all power and ground network wires in a floor plan design. A local attribute, however, will only be imposed on power and ground network wires that are proximal to a specific block or that are located within a specific region of the floor plan design.

With various embodiments of the invention, the circuit layout determination module 207 may combine both the global and local attributes. For example, the circuit layout determination module 207 may first apply the global attributes, which typically are rule-driven, for all blocks. These rules could be placed in a text file and loaded into the circuit attributes storage module 209 as a group, entered on an individual basis through a user interface to the tool 201, or a combination of both. The circuit layout determination module 207 can then apply the local attributes so as to override the global attributes in the area of the appropriate blocks. Like the global attributes, the local attributes rules may be placed in a text file and loaded into the circuit attributes storage module 209 as a group, entered on an individual basis through a user interface to the tool 201, or a combination of both.

For wire routing, such as power and ground network wire routing, global attributes may be derived based upon any number of desired considerations, such as power consumption or block size. The attribute values for all blocks in a design can be entered into the circuit attributes storage module 209 as a group, or entered on an individual basis through a user interface. Once the specific attributes are defined, the circuit layout determination module 207 can repetitively reconstruct a main power ground wire network very quickly after every major or minor adjustment of block placement using the visibility graph for the floor plan design.

For example, some embodiments of the invention may allow a user to specify power consumption values for a block. These attributes values may then be employed with a designated watt-per-micron-width value, which defines how much power a given width of a wire can provide or dissipate while staying within a desired temperature range. With various embodiments of the invention, the watt-per-micron-width value may be designated in advance or alternately provided by a user of the tool 201, either through an attribute file or through a user interface for the tool 201. Using these attributes, the circuit layout determination module 207 can easily determine the minimum required width of the power and ground network wires around each block. Further, by assuming that the first preferred metal layer for each orthogonal wire direction is the default layer, as discussed above, the circuit layout determination module 207 also can calculate the desired wire widths and layer placement for the power and ground network wires relative to all sides of all blocks that have power and ground input pins.

It should be noted that, when using a power consumption attribute value for an entire block, the calculated width for the power and ground network wires would be divided by number of sides of the block that contain pins of specific number of power and ground circuits. Accordingly, various embodiments of the invention may designate the attributes in the circuit attributes storage module 209 as:
SetBlockPowerConsumption<masterName><powerWatts>
SetPGMicronPerWattRatioByNet<netName><micronPerWatt>/*<netName>=“*” for all PG nets */
   where <masterName> is the name of the block for which the attribute is being set, <powerWatts> is the designated power consumption for that block, <netName> is the name of the power/ground network for which the wire length is being determined, and <micronPerWatt> is the amount of power (per unit) that a given width of a wire line will dissipate or provide while remaining within a desired temperature range.

If only a subset of blocks in a design have associated power consumption data, the circuit layout determination module 207 may interpolate or extrapolate power consumption based on the dimension of the blocks when compared with the power consumption data and the dimensions of the blocks having associated power consumption data. Using this interpolated or extrapolated power consumption data, the circuit layout determination module 207 can easily determine a wire width for power/ground network wires proximal to blocks that do not have associated power consumption data.

If power consumption attribute values associated with blocks are not readily available for use, various embodiments of the invention may alternately or additionally allow for the use of dimension-based attributes. For example, some embodiments of the invention may provide a command allowing a user to submit a number reflecting the power and ground network wire width per area unit for an associated block, such as:
SetPGMicronPerBlockArea<micronPerArea>

With this type of designation, the field <micronPerArea> may be in a <micron>*<micron> unit. Using this attribute, the circuit layout determination module 207 can calculate the required main power and ground network wire widths for all sides of a block based upon the total area of the block.

Some embodiments of the invention may even allow for mixed use of both power consumption attribute values and dimension-based attribute values as global attributes. When in conflict, for example, some embodiments of the invention could designate that a power consumption based attribute would take precedence over a dimension-based attribute.

Because power and ground network wires forming “core” rings are very common and typically cannot be derived from power consumption data or even dimension data for blocks, various embodiments of the invention may additionally allow the widths and layer assignments of power and ground network wires to be specified. For example, some embodiments of the invention may allow a user to specify the direction, layer and width of a core ring wire using a command such as
SetPGCoreRingWidth<netName><direction><layer><width>
   where <netName> is the name of the power/ground network forming a core ring, <direction> specifies the direction in which the wire is oriented (e.g., horizontal or vertical), <layer> is the layer of material in which the wire will be formed, and <width> is the width of the wire.

With this type of command, a “wildcard” character (such as the “*” character) could be used to represent all applicable matches in the <netName> and <direction> fields, thereby allowing the command to be used to simultaneously designate the attributes of multiple core ring power/ground network wires. The <netName> could either specify a power or ground network. If a power/ground network serving as a core ring does not have a specified associated core ring attribute, then the circuit layout determination module 207 may simply exclude the automatic determination of the routing for that power/ground network. With various embodiments of the invention, an attribute for a power/ground network serving as a core ring may override any other attributes imposed on the same area of the floor plan design, such as an attribute corresponding to a block when the block is located adjacent to the core ring.

As previously noted, local attributes typically will override global attributes. Local attributes normally will be associated with a set of one or more specific blocks, and in some uses, with directional attributes that can be used to designate one or more specific sides of a block. Thus, a block-based attribute may be employed to direct construction of wiring routes next to a specific side of the block. The direction/side specification may be relative to the associated block's normal orientation or transformation, making the attribute rotation independent. Various embodiments of the invention may thus provide commands such as
SetBlockPGAttribute<blockName><side><attributeName><value>
   to designate a local attribute. With this command example, the field <blockName> is an instance name for the attribute (i.e., associating the attribute with a specific block), and not a master name since it is a local attribute. The field <side> may allow, for example, a value selected from the group of TOP,BOTTOM, LEFT, RIGHT, while the value of the <attributeName> field may be any one or more of a desired set of attributes associated with a side of block.

These attributes may include, for example, such parameters as a “reserve” value to reserve extra space in microns, a “noLessThan” value to specify that the wire be offset from the corresponding block by no less than a designated space in total, an “equal” value designating that the wire be a distance from the corresponding block by a space exactly equal to a specified value, a “width” value designating the width of all of the power/ground network wires for the associated side of a block, a “layer” value specifying the metal layers in which the power/ground network wires will be routed, and a “pinReserve” value specifying that at least the designated space be left between the power/ground network wire route and a boundary to protect pin accessibility. With the “pinReserve” attribute, the default value may be some minimal spacing distance plus some adjustment if space in the design allows. As will be appreciated by those of ordinary skill in the art, a “wildcard” character (e.g., an “*”) can be used to designate all possible selections.

In some situations, two local attributes may conflict. For example, if a block A is located to the “left” of block B by a distance of 100 microns and a power/ground network wire running between the blocks has a width of 12 microns, the following two local attribute attribute commands (with values given in microns) will present a conflict:
SetBlockPGAttribute A RIGHT equal 40.0
SetBlockPGAttribute B LEFT noLessThan 50.0
   since a wire with a width of 12 microns cannot be both 40 microns from the block A and no less than 50 microns from the block B.

When two attributes conflict, any desired technique may be used to resolve the conflict. For example, with a wire width attribute conflict, various embodiments of the invention may employ an average of the two attribute values, in order to minimize a maximum violation of the attributes. For a space attribute conflict, various embodiments of the invention may employ an average of the two attribute values, in order to minimize a maximum violation of the attributes. With a conflict of layer attributes, various embodiments of the invention may simply designate the lowest specified layer.

Some embodiments of the invention may allow a user to designate local attributes for a group of two or more blocks. This feature may be useful, for example, where the attributes are used to route wires around a group of blocks so as to form a guard band. This feature may also be used to create power/ground network rings around a group of blocks. For example, various embodiments of the invention may provide commands such as
SetBlockToGroup<blockName><groupName>
   which designates the block specified by <blockName> as a member of the group specified by <groupName>,
SetGroupNets<groupName>{<netName> }
   which associates an existing wire network with the group of blocks, and
SetGroupPGAttributes<groupName><side><attributeName><value>
   where <groupName> specifies the group of blocks, <side> designates the side of the group to which the attribute will be applied, <attributeName> specifies the type of attribute and <value> specifies the value of the attribute. If, for example, a specified network is a “dummy” network (i.e., a network with no defined pin connections), then the network will be treated as a guard band formed around the group of blocks.

With some embodiments of the invention, a local group attribute may be imposed on a block in or near the group that has a conflicting attribute. Alternately or additionally, some embodiments of the invention may resolve a conflict between a local group attribute and a local attribute associated with a block in or near the group. For example, if a local group attribute is being applied to a wire network serving as a power wire network (i.e., a “VDD” or direct-current voltage at drain wire network), and a block positioned near the group specifies a conflicting attribute for a wire network serving as a power wire network for that block, then the two power wire networks may be merged into a single power wire network large enough to comply with both attributes.

Under some circumstances, various levels of attributes may conflict. For example, a group based attribute may conflict with a local attribute for a single block, which in turn may conflict with a global attribute. Various embodiments of the invention may resolve these conflicts according to any desired technique. For example, some embodiments of the invention may resolve attribute conflicts in favor of the highest precedence according to the following descending precedence hierarchy:
Group-based attributes, such as guard band width, spacing, side, layer, networks
Local attributes, such as block-specific width, spacing, side, layer
Global attributes, such as power consumption parameter-based width/spacing determinations, dimension-based width/spacing determinations, macro-type based attributes (i.e., attributes generally assigned to analog blocks or generally assigned to digital blocks), and general default parameters.

It should be appreciated that, with various embodiments of the invention, the attributes defined in the circuit attributes storage module 209 may only be employed for automatic construction of a main power and ground wire network. With some embodiments, a user may choose to manually edit a power/ground wire network or other wire routing. With these embodiments, the user interface 301 may offer a conventional set of commands (core ring, block ring, stripe) to modify the wire routing in the floor plan design.

Creation Of Wire Routing

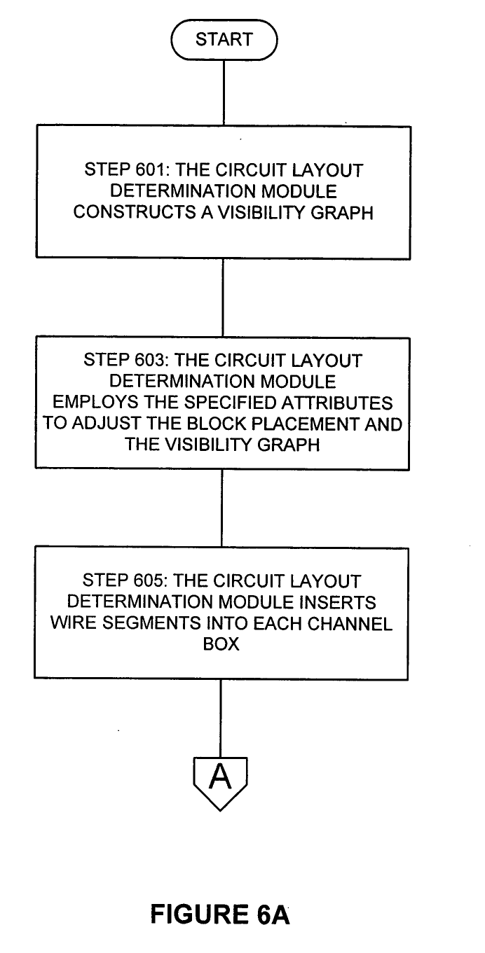

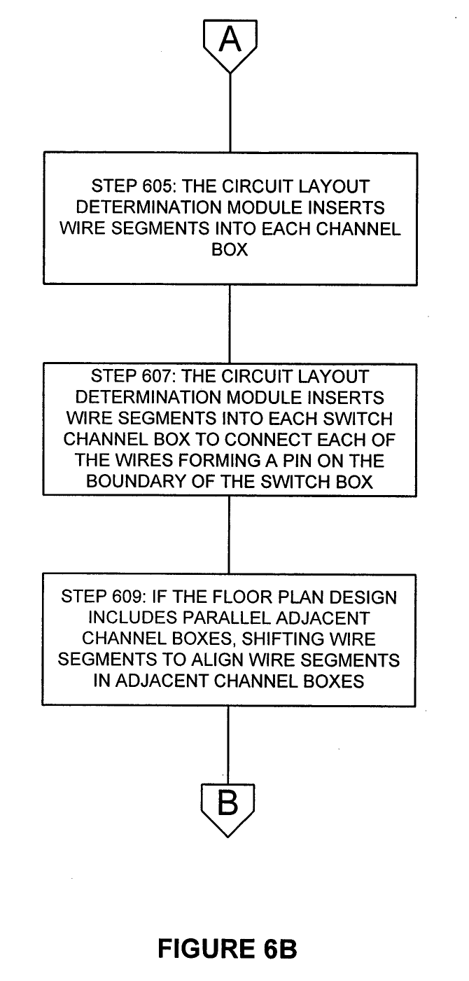

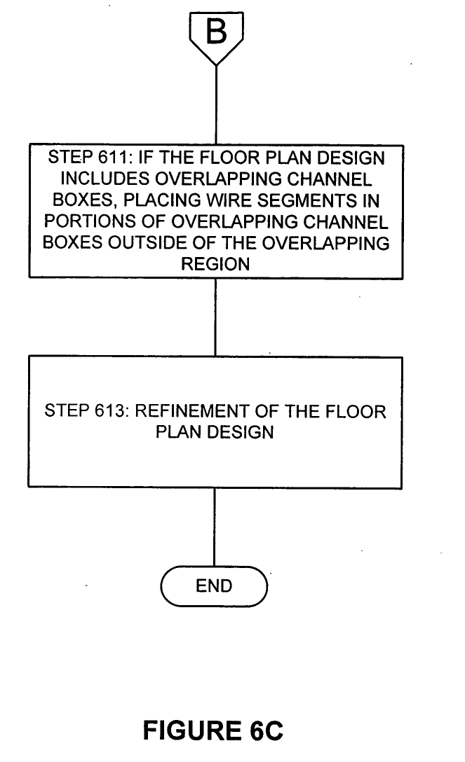

With various embodiments of the invention, the circuit layout determination module 207 may employ a multi-step algorithm to automatically determine the routing of a wire network, such as a power/ground wire network. This algorithm may include, for example, (1) the construction of a visibility graph corresponding to the current arrangement of the floor plan design, (2) wire segment insertion into the design, (3) initial construction of the wire routing, and, (4) refinement of the wire routing. This algorithm will be discussed in more detail below, and is illustrated in FIGS. 6A and 6B.

Given a block placement without any overlap among blocks, and assuming that a user has successfully imposed the desired global and local attributes for the block placement, the circuit layout determination module 207 first constructs a visibility graph in step 601 as described in detail above. Because the visibility graph construction process can be implemented very quickly, there typically is no need for an incremental update of the graph for changes to the floor plan design. Instead, the visibility graph may be reconstructed even after minor placement changes in the floor plan design, which serves to increase the stability of tool 201. It should be noted that, in some situations, an incremental update of an existing visibility graph may be more complex and time consuming than a total construction of a new graph. Some embodiments of the invention, however, may still incrementally update an existing visibility graph for changes in a floor plan design.

Once a visibility graph is constructed, the circuit layout determination module 207 will employ the specified attributes to adjust the block placement (and thus the visibility graph) in step 603. This process may include, for example, adjusting the size of the channel boxes (i.e., the “box” formed by the channels of empty area between the blocks, as previously noted) to ensure enough space has been reserved for introduction of the power and ground network wires into channel boxes. These adjustments may be made based upon the network routing attributes provided in the circuit attributes storage module 209. For example, the attributes for a network may require a wire width of 10 microns, a distance between the wire and a block A of 40 microns, and a distance between the wire and a block B of at least 50 microns. With these attributes, the circuit layout determination module 207 may move the blocks A and B to ensure that they are separated by at least 100 microns (i.e., to ensure that the channel box has a width of 100 microns so as to comply with the specified attributes).

After a visibility graph has been successfully constructed and the channel boxes have been modified to ensure that there is enough space for wire segments, in step 605 the wire segments are inserted into each channel box. More particularly, if a channel box corresponds to a horizontal primary edge in the visibility graph, then a vertical wire segment is inserted into the channel box. Similarly, a horizontal wire segment for each needed power and ground network is inserted into each channel box corresponding to a vertical primary edge in the visibility graph. As discussed in detail above, the width of the inserted wire segment is calculated based upon the applicable attributes for that channel box, and the wire is assigned to a wire layer corresponding to the power or ground network to which the wire will belong. It should be noted that, when desired, a designer may impose local attributes to partially or completely rid a channel box of a wire segment.

When this process is completed, the channel boxes corresponding to the primary edges of the complete visibility graph contain inserted wire segments. The length of each wire segment typically will equal the height or width of the channel box, depending upon whether the wire segment is horizontal or vertical. Also, the center of each wire segment typically will be located at the center of its corresponding channel box. In some floor plans, a channel box will border a block belonging to a group associated with one or more group-based attributes (such as the type that may be used to create guard band wires). The circuit layout determination module 207 tests the channel box at each side of every block in such a group to ensure that the channel boxes surrounding these blocks comply with the attributes for the group.

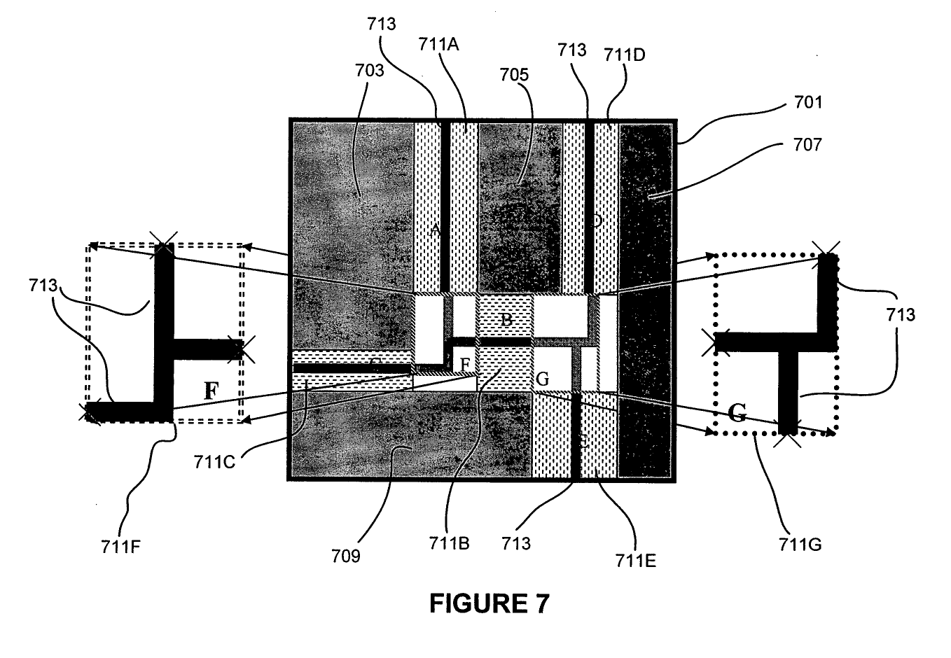

After the insertion of wire segments into all of the channel boxes (except for those excluded from receiving a wire segment by one or more attributes ) has been completed, the floor plan design contains interweaved wire segments. For example, as shown in FIG. 7, the floor plan design 701 includes blocks 703-709, with box channels 711 between various blocks. For example, a horizontal box channel 71 1A is located between block 703 and 705, while another horizontal box channel 711D is located between block 705 and block 707. Still another horizontal box channel 711E is located between block 707 and block 709. Vertical box channel 711B is then located between block 705 and block 709, and vertical box channel 711C is located between block 703 and block 709. As shown in this figure, a wire 713 is inserted into each channel box 711.

The intersection of channel boxes 711 forms “switch” channel boxes (i.e., areas where the direction of the wires 713 switch) or switch boxes. For example, the intersection of channel box 711A, channel box 711B, and channel box 711C form the switch box 711F (shown enlarged at the right-hand side of FIG. 7). Similarly, the intersection of channel box 711B, channel box 711D and channel box 711E form the switch box 711G (shown enlarged at the left-hand side of FIG. 7). Thus, the wire segments in the channel boxes 711 form pins on the boundaries of the switch boxes. The area of the switch boxes may be further defined to be the minimal area containing pins (i.e., connections) to wires in the channel boxes 711. In step 607, connection wires are formed within each switch box to connect each of the wires forming a pin on the boundary of that switch box. (It should be noted that, while FIG. 7 does not illustrate each the wires in the switch boxes 711F and 711G as being fully aligned with its corresponding pin, in actuality each wire segment within a switch box would be accurately aligned with its corresponding pin.) The routing of these connections wires within a switch channel box may be made according to any desired conventional technique. For example, various embodiments of the invention may employ automatic area-based routing techniques, point-to-point routing techniques, and pattern-based routing techniques to route the wires within the channel boxes. These routing techniques are well known in the art, and thus will not be discussed in detail here.

When the components of a floor plan design are actually physically constructed, wires running in a vertical direction are usually formed in one or more different metal layers from wires running in a horizontal direction. Accordingly, some embodiments of the invention may replace joints between differently directed wires with a ‘contact array’ (i.e. array of contacts or vias) during the wire routing process. Wires associated with group-based attributes, such as wires forming a guard band, also can be connected in this way.

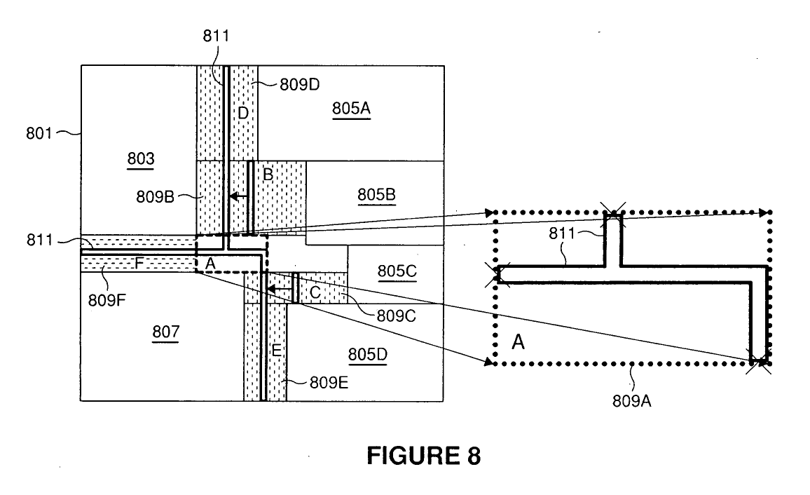

The routing process described above and illustrated in FIGS. 6A and 6B would be complete if all of the blocks within a floor plan design are rectangular and the channel boxes do not overlap. However, there are two special cases in which one or both of these conditions do not occur. An example of the first case is shown in FIG. 8. As seen in this figure, the floor plan design 801 includes blocks 803-805, but the shape of rectilinear block 805 is represented by a set of differently-sized rectangles 805A-805D. During the construction of a corresponding visibility graph as described above, the graph would have no edges among the rectangles 805A-805D of the same block 805. In other words, internal edges having the same ‘node’ on both ends of the edge (i.e., edges between the same block) would typically not be permitted in the visibility graph. Thus, the visibility graph for a floor plan design with a rectilinear block as shown in FIG. 8 would include parallel edges adjacent to one another. The floor plan design represented by such a visibility graph would correspondingly have parallel channel boxes adjacent to one another (i.e., not separated by a channel box running in a different direction so as to form a switch channel box), such as the adjacent channel-boxes 809B and 809D and adjacent channel boxes 809C and 809E.

As seen in FIG. 8, after the initial construction of the wire segments 811 in the channel boxes 809B-809F, the wire segments 811 in adjacent channel boxes 809B-80D appear ‘fractured’ at the boundaries of the channel boxes 809B-809D. Various embodiments of the invention may address this discrepancy by shifting the wire segment in one channel box to connect to the wire segment in an adjacent channel box in step 609. For example, with the floor plan design illustrated in FIG. 8, the wire segment 811 in channel box 809B is shifted to align with the wire segment 811 in channel box 809D. Similarly, the wire segment 811 in channel box 809C is shifted to align with the wire segment 811 in channel box 809E. After the shifting process is complete, a switch box 809A is formed, and connecting wire segments can be routed in the switch box 809A as previously described in detail.

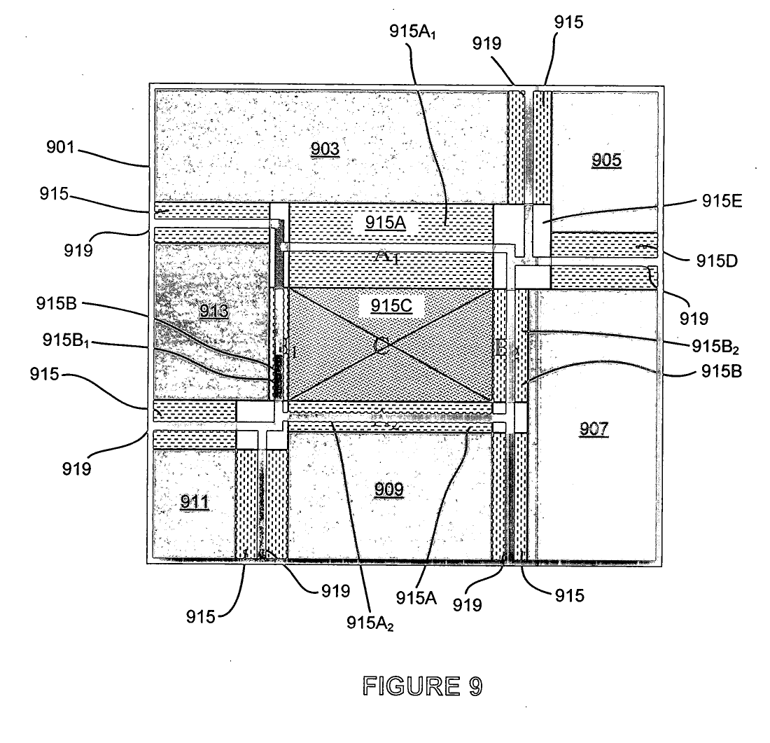

In some floor plan design configurations, the channel boxes could actually overlap one another. For example, as shown in FIG. 9, a floor plan design 901 includes blocks 903-913, with a channel box 915 formed between each pair of adjacent blocks. Additionally, a vertical channel box 915A is formed between block 903 and block 909, while a horizontal channel box 915B is formed between block 907 and block 913. As a result, the vertical channel boxes 915A and 915B intersect in rectangle 915C.

To avoid inadvertently creating shorts between wire segments in overlapping channel boxes, in step 613 various embodiments of the invention may route wire segments in those portions of overlapping channel boxes outside of the overlapped region. For example, in FIG. 9 the rectangular overlapping region 915C effectively segments the vertical channel box 915A into a channel box portion 915A, and a separate channel box portion 915A₂. Similarly, the rectangular overlapping region 915C divides the horizontal channel box 915B into a channel box portion 915B₁ and a separate channel box portion 915B₂. Thus, various embodiments of the invention will insert two wire segments into both channel boxes 915A and 915B instead of one. More particularly, the circuit layout determination module 207 will insert a wire segment 919 into the channel box portion 915A₁ and another wire segment 919 into the channel box portion 915A₂. Similarly, the circuit layout determination module 207 will insert a wire segment 919 into the channel box portion 915B₁ and another wire segment 919 into the channel box portion 915B₂. The routing within each resultant switch box (i.e., the switch channel boxes formed by the segmented channel box portions) can then be performed as previously described.

In some instances, this type of wire routing technique may produce redundant wire segments. With various embodiments of the invention, any redundant wire segments can be prohibited or removed by designating appropriate local attributes. For example, with the floor plan design shown in FIG. 9, a user may determine that the wire segment routed through the channel box portion 915B₁ is redundant in view of the wire segment routed through the channel box portion 915B₂. The user can thus address this redundancy by setting the local attributes to prohibit or remove the wire segment routed through the channel box portion 915B₁.

Design Refinement

Once the routing of wire segments for the desired wire networks in a floor plan has been completed, various embodiments of the invention may allow a user to refine the floor plan design in step 613. For example, a user may wish to minimize the length of the wires in the floor plan design, or to employ the shortest connection distance between wires in order to reduce voltage drop. Further, the user typically would desire to make these refinements without increasing congestion of the wire routing. Accordingly, some embodiments of the invention may allow a user to manually revise the floor plan design in order to refine the network connections.

Alternately or additionally, various embodiments of the invention may provide a rule-based system to identify and make desired refinements in the floor plan design. For example, a user may employ a rule that would shift the wire segment 919 in channel box portion 915A₁ to align with the wire segment 919 in channel box 915D. Such are rule might be described, e.g., as an instruction to align two same-direction wires if those wires can be made collinear by moving one wire less than a given distance in microns. As will be appreciated by those of ordinary skill in the art, this refinement would simplify the joint structure in the switch channel box 915 and shorten the connection between the two wire segments 919. Still further, various embodiments of the invention may employ various techniques to optimize the dimensions and routing of the wire networks in a floor plan design, such as the techniques disclosed in U.S. Provisional Patent Application No. 60/612,877, entitled “Chip Level Power/Ground Network Optimization Methodology,” naming Ta-Cheng Lin et al. as inventors, which application is incorporated entirely herein by reference, or the use of the Simplex algorithm developed by George Dantzig (or similar algorithm) to minimize the area of wires in the floor plan design.

In addition to refining the floor plan design by optimizing wire dimensions and routing, various embodiments of the invention may alternately or additionally allow a user to. automatically add wire connections (sometimes referred to as “stripes”) between the wire networks and the appropriate blocks. For example, various embodiments of the invention may provide a user with commands to specify a stripe's control layer, a stripe's width, a stripe's start location, a stripe's end location, spacing between a stripe and another stripe of block, an interval between stripes, and the like. Various embodiments of the invention also could provide design rule checking tools to ensure that the finished floor plan design complies with predetermined design rules, and automatic antenna (i.e., a dangling wire segment) trimming features.

### CONCLUSION

Accordingly, various embodiments of the invention provide a tool for elastically assembling a floor plan design that automatically repositions blocks in response to the user's movement of a target block, and which can immediately illustrate for the user how movement of the target block will impact various features of the floor plan design. While the invention has been described with respect to specific examples including presently preferred modes of carrying out the invention, those skilled in the art will appreciate that there are numerous variations and permutations of the above described systems and techniques that fall within the spirit and scope of the invention.

1. A method for creating a floor plan design for a circuit, comprising:
displaying at least a portion of an initial floor plan design having a plurality of blocks;
receiving block movement input from a user designating movement of a target block;
in response to receiving the block movement input from the user,
determining if the designated movement of the target block requires movement of a second block adjacent to the target block,
if the designated movement of the target block requires movement of a second block adjacent to the target block, moving the second block to allow movement of the target block, and
moving the target block; and
displaying the floor plan design with moved blocks.

2. The method recited in claim 1, further comprising creating a new floor plan design with the moved blocks.

3. The method recited in claim 1, further comprising:
in response to receiving the block movement input from the user,
determining if movement of the second block requires movement of a third block adjacent to the second block, and
if movement of the second block requires movement of a third block adjacent to the adjacent block, moving the third block to allow movement of the second block.

4. The method recited in claim 3, further comprising:
in response to receiving the block movement input from the user,
determining if movement of the third block requires movement of a fourth block adjacent to the third block, and
if movement of the third block requires movement of a fourth block adjacent to the third block, moving the fourth block to allow movement of the third block.

5. The method recited in claim 1, wherein determining if the designated movement of the target block requires movement of an adjacent block to the target block is based upon one more circuit attributes designated for the floor plan design.

6. The method recited in claim 5, wherein the circuit attributes include an attribute defining a minimum distance between blocks.

7. The method recited in claim 5, wherein the circuit attributes include a minimum distance between the target block and the second block.

8. The method recited in claim 5, wherein the circuit attributes include a minimum distance between a side of the target block proximal to the second block and the second block.

9. The method recited in claim 5, wherein the floor plan design includes routing of at least one wire segment between the target block and the first block.

10. The method recited in claim 9, wherein the circuit attributes include a minimum width of the wire segment.

11. The method recited in claim 9, wherein the circuit attributes include a minimum distance between the wire segment and the target block or the first block.

12. The method recited in claim 1, wherein the floor plan design includes routing for at least one group of wires.

13. The method recited in claim 12, further comprising showing an amount of congestion associated with the routing for the at least one group of wires.

14. The method recited in claim 12i further comprising:
in response to receiving the block movement input from the user,
determining if movement of the target block requires changing the routing of one or more wires in the at least one group of wires, and
if movement of the target block requires changing the routing of one or more wires in the at least one group of wires, changing the routing of the one or more wires;
and
displaying the floor plan design with rerouted wires.

15. The method recited in claim 14, further comprising showing an amount of congestion associated with the changed routing for the at least one group of wires.

16. The method recited in claim 14, wherein the changed routing of the one or more wires is based upon one more circuit attributes designated for the floor plan design.

17. The method recited in claim 16, wherein the circuit attributes include a minimum distance between a side of a moved block and a wire segment adjacent to the side of the moved block.

18. The method recited in claim 16, wherein the circuit attributes include a minimum distance between a moved block and a wire segment adjacent to the moved block.

19. The method recited in claim 16, wherein the circuit attributes include a minimum width of a wire segment adjacent to a moved block.

20. The method recited in claim 12, further comprising:
if the designated movement of the target block requires movement of a second block adjacent to the target block, in response to receiving the block movement input from the user determining if movement of the second block requires changing the routing of one or more wires in the at least one group of wires, and
if movement of the adjacent block requires rerouting of one or more wires in the at least one group of wires, changing the routing of the one or more wires.

21. The method recited in claim 12, further comprising:
receiving wire rerouting input from the user; and
in response to receiving the wire rerouting input from the user, modifying the changed routing of the one or more wires.

22. The method recited in claim 12, wherein the at least one group of wires includes power wires.

23. The method recited in claim 12, wherein the at least one group of wires includes ground wires.

24. The method recited in claim 12, wherein the at least one group of wires includes signal wires.

25. A computer medium storing thereon instruction for performing the method recited in claim 1.

26. A floor plan design creation tool, comprising:
a floor plan storage module that stores an initial floor plan including a plurality of block;
a user interface generation module that
creates a user interface displaying the initial floor plan, and
receives movement input from a user designating movement of a target block in the initial floor plan
a circuit layout determination module that
moves the target block in the initial floor plan design in response to the user interface generation module receiving movement input from a user,
determines if the designated movement of the target block requires movement of a second block adjacent to the target block, and
if the designated movement of the target block requires movement of a second block adjacent to the target block, moving the second block.

27. The tool recited in claim 26, further comprising a circuit attributes storage module storing attributes for routing one or more wires in a floor plan design.
